(19) United States
(12) Patent Application Publication
(10) Pub. No.: US 2019/0196984 A1
(43) Pub. Date: Jun. 27, 2019

(54) METHOD, APPARATUS, AND SYSTEM FOR DYNAMIC MANAGEMENT OF INTEGRITY-PROTECTED MEMORY

(71) Applicant: QUALCOMM Incorporated, San Diego, CA (US)

(72) Inventors: Darren LASKO, Forest, VA (US); Roberto Avanzi, Munchen (DE)

(21) Appl. No.: 15/855,184

(22) Filed: Dec. 27, 2017

(51) Int. Cl. G06F 12/14

(52) U.S. Cl. CPC G06F 12/1433; G06F 2212/1052

(57) ABSTRACT

In certain aspects of the disclosure, an apparatus, comprises a first memory having a plurality of bits. Each bit of the plurality of bits of the first memory is associated with a region of a second memory, and each bit indicates whether the associated region of the second memory is to be integrity-protected. The first memory further stores a first minimum set of data necessary for integrity protection (MSD) of an associated first integrity protection tree when a first bit of the plurality of bits is set to a value indicating that the first associated region of the second memory is to be integrity-protected. Regions of the second memory that are integrity-protected may be non-contiguous, and may be adjusted during run-time.

### BACKGROUND

### Field

Aspects of the present disclosure relate generally to integrity-protected memory, and more specifically to dynamic management of integrity-protected memory during run-time.

### Background

A computing device may be exposed to various kinds of attacks on their system memories (e.g., DRAM), as a result of attackers wanting to take control of the computing device for the purposes of executing malicious code (including by triggering a replay of a code and/or data segment that has been replaced with “rolled-back” code and/or data, but appears to be legitimate from the perspective of the computing device, usually referred to as replay protection), read sensitive data that resides within the system memory, or otherwise defeat the computing device's security measures. This may be an issue in all computing environments, but may be especially important in the mobile processing and server environments, since those environments often handle sensitive or confidential data, and are thus readily targeted by attackers.

Integrity protection of the system memory of the computing device can provide a solution to the above-described memory modification and rollback attacks, and thus support for integrity protection is desirable from both a technical and a commercial standpoint. One approach is to apply integrity protection to the entire system memory. However, this approach carries with it significant costs—performing the operations associated with integrity protection (e.g. creating, maintaining, and managing the integrity tree structures) for the entire memory system and on every memory transaction is computationally expensive and involves significant system memory overhead. Thus, it is undesirable to provide integrity protection for the entire system memory. Another approach is to pre-define regions of integrity-protected memory within the system memory, but it is often difficult to know a priori how much integrity-protected memory will be needed by the various software programs that will be executed by the computing device. Additionally, pre-defining regions of integrity-protected memory in this way reduces the flexibility of the system and makes overall system memory management more cumbersome.

It is thus desirable to design a memory system that is able to dynamically expand or contract the amount of memory designated as integrity-protected memory within the memory system.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In a particular aspect, an apparatus comprises a first memory and a second memory. The first memory comprises a plurality of bits, where each bit of the plurality of bits of the first memory is associated with a region of the second memory. Further, each bit of the plurality of bits of the first memory indicates whether the associated region of the second memory is to be integrity-protected. Further, a first bit of the plurality of bits of the first memory may be associated with a first region of the second memory, and a second bit of the plurality of bits of the first memory may be associated with a second region of the second memory, where the first region of the second memory and the second region of the second memory are non-contiguous.

In another aspect, a method comprises setting a first bit of a plurality of bits of a first memory. Each bit of the plurality of bits of the first memory is associated with a region of a second memory, and indicates whether the associated region of the second memory is to be integrity-protected. The method may further comprise setting a second bit of the plurality of bits of the first memory. The second bit indicates that an associated second region of the second memory is to be integrity protected, and the second region of the second memory is non-contiguous with the first region of the second memory.

In yet another aspect, an apparatus comprises a means for storing integrity protection information including a plurality of indicators. The apparatus further comprises a means for storing. Each indicator of the plurality of indicators is associated with a region of the means for storing, and each indicator indicates whether the associated region of the means for storing is to be integrity-protected. Further, a first indicator may be associated with a first region of the means for storing and a second indicator may be associated with a second region of the means for storing. The first region and the second region may be non-contiguous.

In yet another aspect, a non-transitory computer readable medium comprises instructions which, when executed by a processor, cause the processor to set a first bit of a plurality of bits of a first memory. Each bit of the plurality of bits is associated with a region of a second memory, and the first bit of the plurality of bits indicates whether an associated first region of the second memory is to be integrity-protected. Further, the instructions may cause the processor to set a second bit of the plurality of bits of the first memory. The second bit indicates than an associated second region of the second memory is to be integrity-protected, where the second region of the second memory is non-contiguous with the first region of the second memory.

One advantage of one or more disclosed aspects is that the disclosed aspects allow for non-contiguous regions of the system memory to have integrity protection, and further allow for the adjustment of which regions of system memory have integrity protection during run-time, which reduces the overhead associated with integrity protection and improves system power and performance characteristics.

### BRIEF DESCRIPTION OF THE DRAWINGS

FIG. 1 is a block diagram of a computing device including a dynamically manageable integrity-protected memory according to certain aspects of the present disclosure.

FIG. 2A is a detailed diagram of certain aspects of the dynamically manageable integrity-protected memory according to certain aspects of the present disclosure.

FIG. 2B is a detailed view of an integrity protection tree that spans on-die memory and DRAM.

FIG. 3 is a flowchart of a method of using a dynamically manageable integrity-protected memory according to certain aspects of the present disclosure.

FIG. 4 is a system-level diagram incorporating a dynamically manageable integrity-protected memory according to certain aspects of the present disclosure.

### DETAILED DESCRIPTION

Aspects of the inventive teachings herein are disclosed in the following description and related drawings directed to specific aspects. Alternate aspects may be devised without departing from the scope of the inventive concepts herein. Additionally, well-known elements of the environment may only be generally described or omitted so as not to obscure the relevant details of the inventive teachings herein.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, certain aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

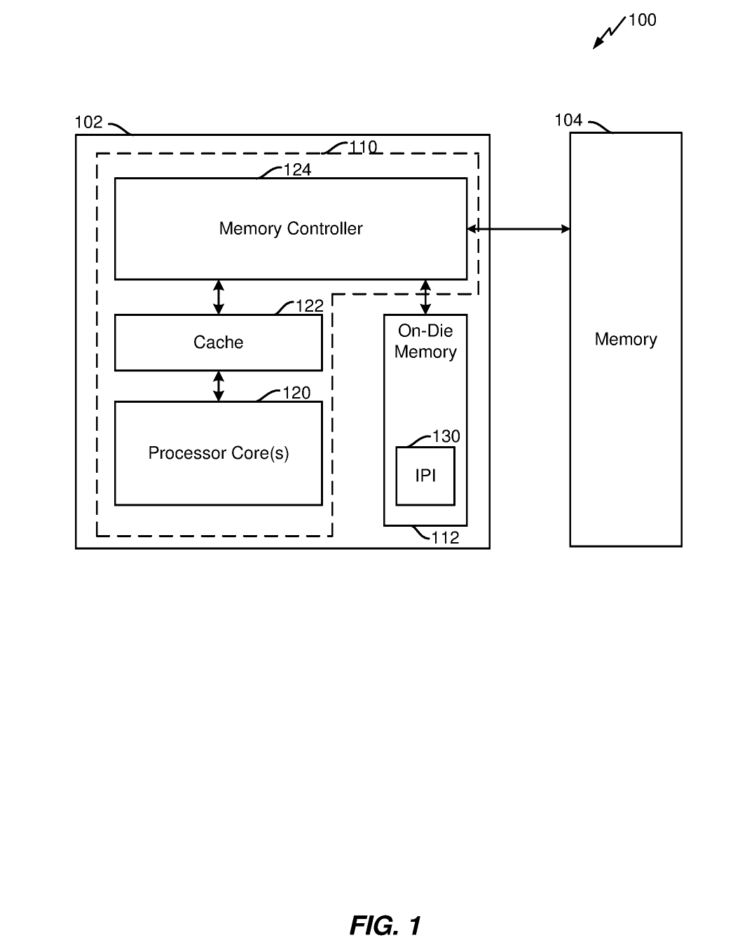

Aspects of the present disclosure include an apparatus for dynamic management of integrity-protected memory. In this regard, FIG. 1 is a block diagram of a computing device 100 including a processor 102 and an associated memory 104, which may be an off-chip DRAM memory in some aspects. The processor 102 comprises a processing complex 110 coupled to an on-die memory 112. In various aspects, the on-die memory 112 may be an SRAM, a last level cache, or a tightly coupled memory. The processing complex 110 comprises processor core(s) 120 coupled to a cache 122 and a memory controller 124. The memory controller 124 provides an interface between the processing complex 110 and the on-die memory 112.

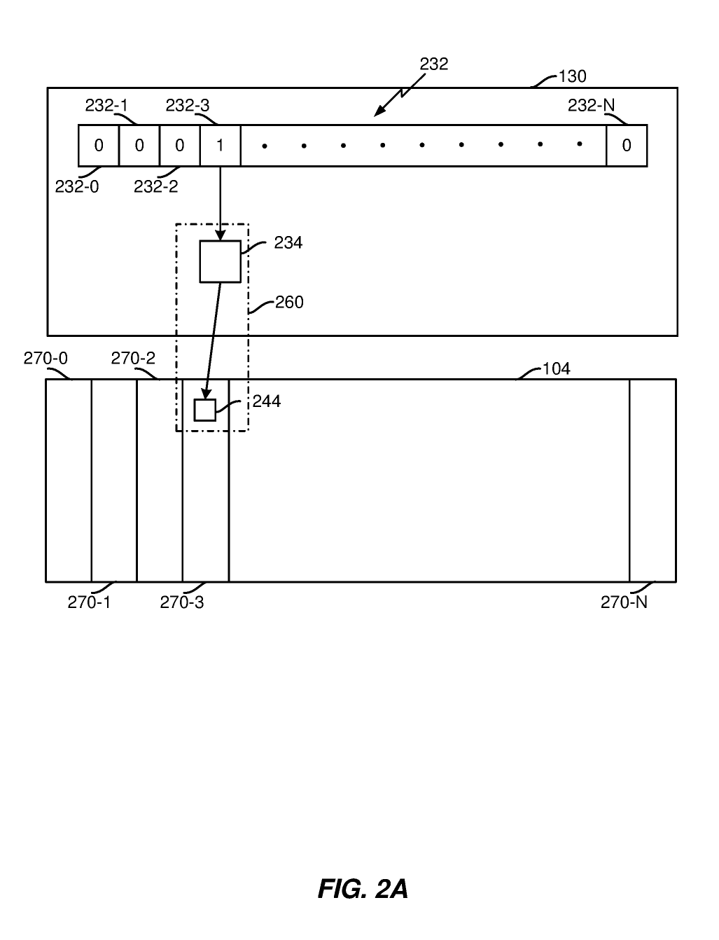

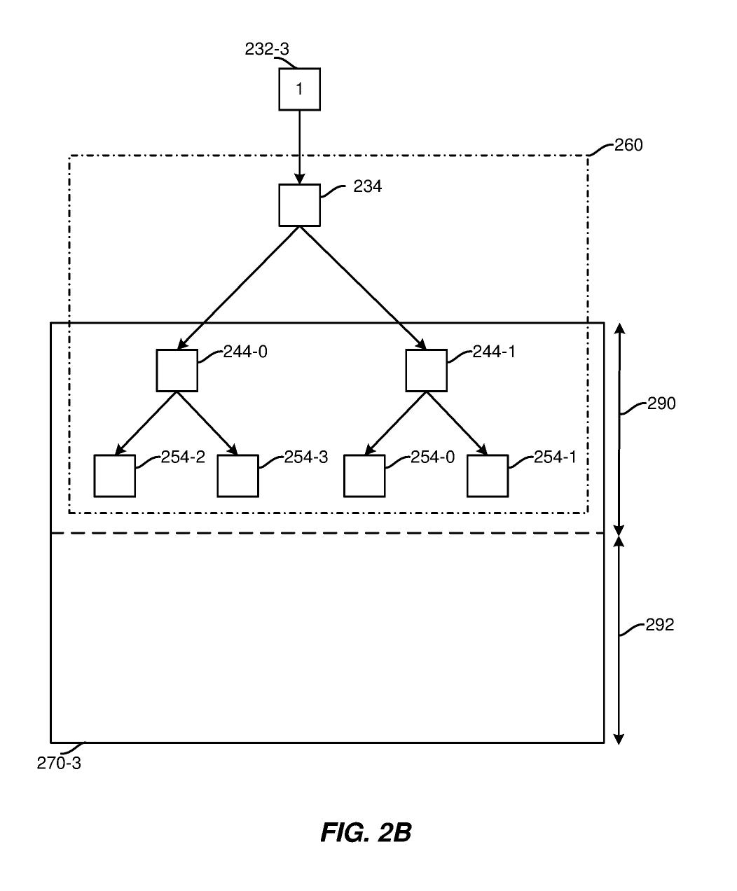

The on-die memory 112 provides secure storage for the minimum set of data necessary to provide integrity protection for the memory 104. In this regard, to provide for dynamic management of integrity protection for the memory 104, in one aspect, the on-die memory 112 includes integrity protection information 130. As will be further explained in reference to FIG. 2, the integrity protection information 130 includes an integrity protection bitmap, which comprises a set of bits, each bit associated with a chunk of memory 104. Each bit indicates whether the associated chunk of memory 104 is to be integrity-protected. The number of total bits in the integrity protection bitmap is based on the size of each chunk of memory, and the total amount of the memory 104 for which integrity protection is desired. For example, in a system having 768 gigabytes (GB) of total memory, if each chunk represents 16 GB of memory, then the integrity protection bitmap would need to comprise 48 bits to protect the entire 768 GB of memory. Of course, other implementations may choose different chunk sizes, or may choose to offer integrity protection for less than the entire addressable area of memory 104. For example, some implementations may specify a certain amount of memory 104 that is reserved for use as integrity protected memory at boot time. Other implementations may allow the amount of memory 104 that is reserved for use as integrity protected memory to dynamically grow over time, and to return an error if software requests additional integrity protected memory and no more is available. However, these are implementation choices, and are all within the scope of the teachings of the present disclosure.

In addition to storing the integrity protection bitmap, the integrity protection information 130 also is configured to store a minimum set of data necessary to provide integrity protection (e.g. a root hash for a standard Merkle integrity protection tree, or a counter and MAC for a Bonsai Merkle tree, as non-limiting examples), hereinafter referred to as the “MSD,” per bit of the integrity protection bitmap that is set to indicate that the associated chunk of memory 104 is to be integrity-protected. Each MSD is associated with an integrity protection tree, and is also associated with a bit of the integrity protection bitmap. Thus, each bit of the integrity protection bitmap is associated with a full integrity protection tree, where only the MSD of the integrity protection tree is stored in the on-die memory 112. By storing only the integrity protection bitmap and MSD for each integrity protection tree in the on-die memory 112 (which is sufficient to provide integrity protection for the associated chunk of memory 104), the size of the on-die memory 112 may be kept relatively smaller, conserving die area.

Although the aspect illustrated in FIG. 1 shows integrity protection information 130 as contained in a discrete on-die memory 112, other aspects may dispose the integrity protection information 130 within a last-level on-die cache (as part of cache 122, or as a separate last-level on-die cache not illustrated), in a separate logic area coupled to a last-level cache and the memory controller 124 (also not illustrated), within the memory controller 124, or other on-die locations, as will be appreciated by those having skill in the art.

Further implementation details of the integrity protection information 130 are illustrated in FIG. 2A. The integrity protection information 130 includes an integrity protection bitmap 232, which contains integrity protection bits 232-0 through 232-N. Each of the integrity protection bits 232-0 through 232-N is associated with a particular chunk of memory 270-0 through 270-N within the memory 104 that can be integrity protected. For any of integrity protection bits 232-0 through 232-N that have been set to indicate that their associated chunk of memory 270-0 through 270-N is to be integrity protected (illustrated in the present example as bit 232-3), the integrity protection information 130 further includes an MSD 234 of an integrity protection tree 260.

As discussed above with reference to FIG. 1, it is sufficient to store the bit indicating whether a particular memory chunk is integrity protected (e.g. bit 232-3) and the MSD 234 of an associated integrity protection tree 260 in a secure location (such as in on-die memory 112) to provide the desired integrity protection for the associated chunk of memory (e.g. chunk 270-3). Thus, the remainder of integrity protection tree 260 (illustrated in this example as integrity protection tree sub-node 244) may be stored in the memory 104, and in one aspect, in the particular chunk of memory 270-3 associated with integrity protection bit 232-3. The remainder of the chunk of memory 270-3 is devoted to storing the information for which integrity protection is desired. In another aspect, a specific region of memory 104 may be reserved for storing the integrity protection tree data for all integrity protection trees, and the chunks of memory 270-0 through 270-N may be reserved for storing the information for which integrity protection is desired. Those having skill in the art will recognize that the choice of how to partition the memory 104 between integrity tree information and other information is a matter of design and implementation choice, and as such, many alternate arrangements are possible, all of which are specifically contemplated as part of this disclosure.

Upon system initialization, re-start, or other similar events, all of the integrity protection bits 232-0 through 232-N may be set to a value indicating that no integrity protection for memory 104 is desired (for example, logic 0 in the illustrated aspect). Thereafter, during run-time, when the operating system or other software needs integrity protection for a chunk of memory, the integrity protection bit 232 corresponding to that chunk of memory is set to a value indicating that integrity protection is desired (for example, logic “1” in the illustrated aspect), and an integrity protection tree associated with that integrity protection bit 232 is created (for example, integrity protection bit 232-3 is set to logic “1,” which triggers creation of the integrity protection tree 260). When a particular chunk of memory 104 no longer needs to be integrity-protected, the associated integrity protection bit can be set to a logic “0.”

FIG. 2B shows a detailed view of integrity protection tree 260 associated with integrity protection bit 232-3. As previously described with reference to FIG. 2A, integrity protection bit 232-3 and the associated MSD 234 are stored in on-die memory 112 (not shown). Integrity protection tree sub-nodes 244-0 and 244-1, and integrity protection tree sub-sub-nodes 254-0, 254-1, 254-2, and 254-3 are stored in the particular chunk of memory 270-3 associated with the integrity protection bit 232-3, and specifically in region 290 of the chunk 270-3. Unless and until chunk 270-3 is released from use as integrity protected memory, region 290 will be inaccessible to normal system software, and will only be accessed by the integrity protection system. Region 292 (in other words, the remainder of chunk 270-3 that is not used for storing information related to the integrity protection tree) may be used for storing the information for which integrity protection is desired.

The number and type of tree sub-nodes and sub-sub-nodes depicted in FIG. 2B is purely for purposes of illustration, and those having skill in the art will recognize that integrity protection trees may be shallower or deeper, or narrower or broader than illustrated without departing from the teachings of the present disclosure. Additionally, although in FIG. 2B integrity protection tree 260 is illustrated as a standard Merkle integrity protection tree, those having skill in the art will recognize that other integrity protection tree types (such as, without limitation, a Bonsai Merkle tree) may be used without departing from the teachings of the present disclosure.

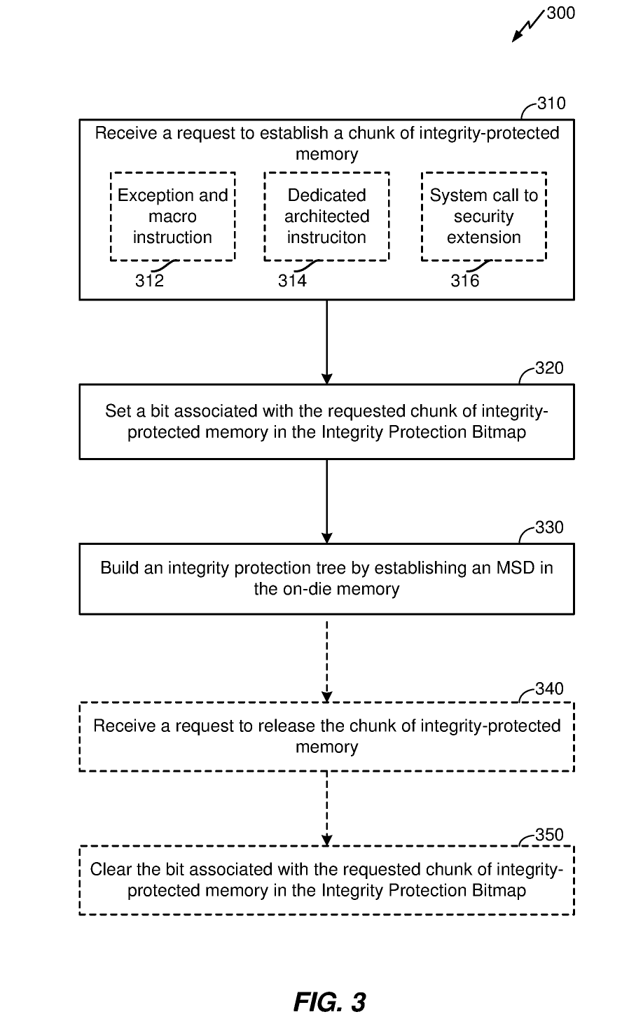

Details of the operation of the integrity protection apparatus described with respect to FIGS. 1, 2A, and 2B are illustrated in FIG. 3. FIG. 3 illustrates a method 300 of dynamically managing integrity-protected memory. The method 300 begins in block 310, where a request is received to establish a chunk of integrity-protected memory. The request may come from an operating system, a hypervisor, firmware, or application, as non-limiting examples, and may be in the form of an exception coupled with a macro instruction 312, a dedicated architected instruction 314, a system call to a security extension 316 (for example, ARM's TrustZone), or other methods known to those having skill in the art.

In block 320, in response to the request described in block 310, a bit associated with the requested chunk of integrity-protected memory is set in the integrity protection bitmap 232. In reference to FIG. 2, for example, integrity protection bit 232-3 is set to a logic “1” value, indicating that the associated chunk of memory is to be integrity-protected.

In block 330, an integrity tree corresponding to the requested chunk of integrity protected memory is established by creating an MSD in the on-die memory. For example, MSD 234 of the integrity protection tree 260 is established in the integrity protection information 130 (which is contained within the on-die memory 112). Once the MSD 234 has been established in the integrity protection information 130, the rest of the integrity protection tree 260 may be created within the associated chunk of memory 104 as needed.

The preceding method steps 310-330 may be repeated each time a request to establish a new chunk of integrity protected memory is received. The requested chunks may be contiguous or non-contiguous to previously requested chunks, and requests for new chunks of integrity protected memory may be made during run-time. Once a chunk of memory has been established as integrity protected as described with respect to blocks 310-330, all memory operations on that chunk of memory are accompanied by a verification and/or update of the associated integrity protection tree by the integrity protection logic. Additionally, the region of the chunk of memory dedicated to storing the integrity protection tree will be inaccessible to normal software.

Further, to reduce system overhead during periods of run-time when less integrity-protected memory is needed, chunks of integrity-protected memory may be released by the operating system and returned to a non-integrity-protected status. For example, in block 340, a request to release the chunk of integrity-protected memory is received. Similar to the request in block 310, this request may be in the form of an exception coupled with a macro instruction, a dedicated architected instruction, a system call to a security extension, or any other method known to those having skill in the art.

In response, in block 350, the bit associated with the requested chunk of integrity-protected memory in the integrity protection bitmap is cleared. Once the bit has been cleared, the associated chunk of memory may be used normally and without the overhead associated with integrity protection, and the region of the chunk of memory dedicated to storing the integrity protection tree may be made accessible to normal software. Blocks 340 and 350 may be repeated as needed by the computing device until there are no longer any regions of memory that are integrity-protected, and as with establishing integrity-protected chunks of memory, releasing chunks of integrity-protected memory may be done during run-time. Thus, a computing device that implements the above-described aspects may be able to effectively manage integrity-protected memory as needed during normal device operation, and need not be reset to change the amount of integrity-protected memory provided, nor pay the overhead associated with integrity-protecting the entire memory system.

Although the preceding description illustrates the integrity protection information 130 as residing specifically in a separate on-die memory 112, in other aspects, the integrity protection information may be stored in the memory controller 124 or elsewhere on die. Similarly, although a single memory controller 124 and on-die memory 112 have been illustrated, related aspects contemplate the use of multiple memory controllers and on-die memories, all of which may implement integrity protection as described in FIGS. 1, 2, and 3. Where multiple memory controllers and on-die memories are included in a system where integrity protection of memory is desired, the integrity protection information 130 may be duplicated across the multiple memory controllers and on-die memories. Additionally, each memory controller may have its own associated on-die memory, or may share on-die memory with other memory controller(s).

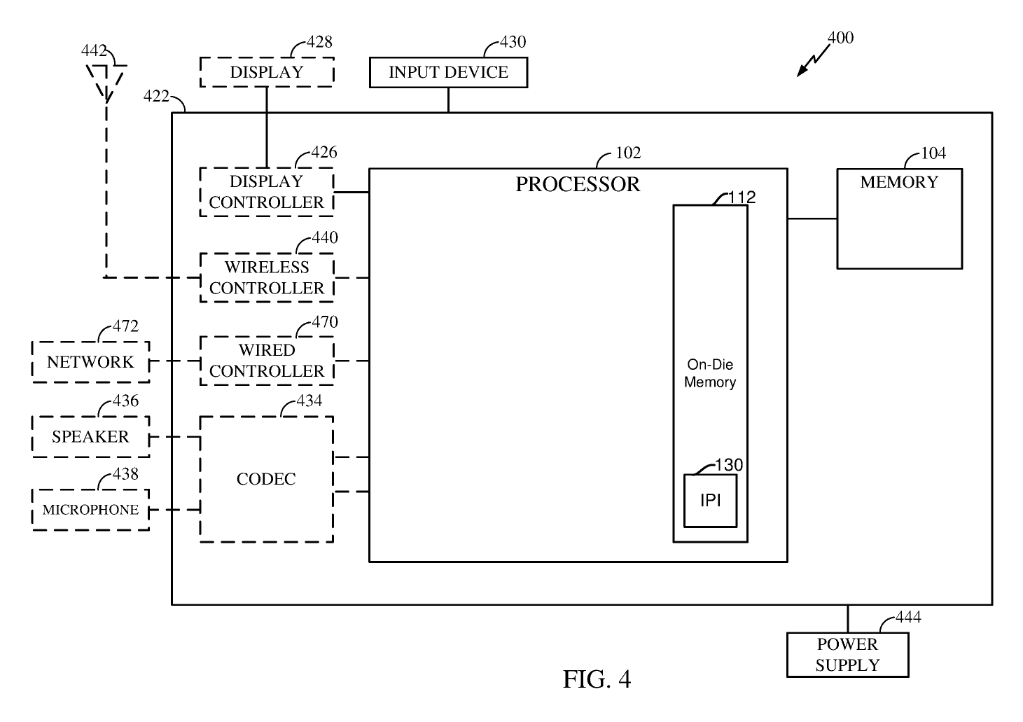

An example apparatus in which aspects of this disclosure may be utilized will now be discussed in relation to FIG. 4. FIG. 4 shows a diagram of a computing device 400 incorporating a dynamically manageable integrity-protected memory as described with respect to FIG. 1 and FIG. 2, and which may be operable in accordance with the method described in FIG. 3. In that regard, the system 400 includes the processor 102 which may incorporate on-die memory 112 and integrity protection information 130 as described with regard to FIGS. 1 and 2. The system 400 further includes a memory 104 coupled to the processor 102, where individual regions of memory 104 may each be associated with a corresponding bit stored in the integrity protection information 130 that indicates whether the associated region of memory 104 is to be integrity-protected. The memory 104 may further store non-transitory computer-readable instructions that, when executed by the processor 102, may perform the method 300 of FIG. 3.

FIG. 4 also shows optional blocks in dashed lines, such as coder/decoder (CODEC) 434 (e.g., an audio and/or voice CODEC) coupled to processor 102 and speaker 436 and microphone 438 can be coupled to CODEC 434; and wireless antenna 442 coupled to wireless controller 440 which is coupled to processor 102. Further, the system 400 also shows display controller 426 that is coupled to processor 102 and to display 428, and wired network controller 470 coupled to processor 102 and to a network 472. Where one or more of these optional blocks are present, in a particular aspect, processor 102, display controller 426, CODEC 434, wireless controller 440, and wired controller 470, for example, may be included in a system-in-package or system-on-chip device 422. Although the memory 104 is illustrated as being included in the system-in-package or system-on-chip device 422, those having skill in the art will recognize that the memory 104 may also be external to the system-in-package or system-on-chip device 422.

In a particular aspect, input device 430 and power supply 444 are coupled to the system-on-chip device 422. Moreover, in a particular aspect, as illustrated in FIG. 4, where one or more optional blocks are present, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-in-package or system-on-chip device 422, such as an interface or a controller.

It should be noted that although FIG. 4 generally depicts a computing device, processor 102 and memory 104, may also be integrated into a mobile phone, a communications device, a computer, a server, a laptop, a tablet, a personal digital assistant, a music player, a video player, an entertainment unit, and a set top box, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for dynamically managing an integrity protected memory, as described in reference to FIG. 3. Accordingly, the invention is not limited to illustrated examples and any means for performing the functionality described herein are included in aspects of the invention.

Further, those having skill in the art will recognize that the described systems and methods for dynamically managing an integrity protected memory may be combined with other mechanisms. For example, integrity protection may be combined with memory encryption (which provides confidentiality of memory contents).

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. An apparatus, comprising:
a first memory comprising a plurality of bits, each bit of the plurality of bits of the first memory associated with a region of a second memory, and each bit indicating whether the associated region of the second memory is to be integrity-protected.

2. The apparatus of claim 1, wherein a first bit of the plurality of bits of the first memory is associated with a first region of the second memory, wherein a second bit of the plurality of bits of the first memory is associated with a second region of the second memory, and wherein the first region of the second memory and the second region of the second memory are non-contiguous.

3. The apparatus of claim 1, wherein the first memory is an on-die memory.

4. The apparatus of claim 1, wherein the first memory is configured to store a first minimum set of data necessary for integrity protection (MSD) of an associated first integrity protection tree when a first bit of the plurality of bits is set to a value indicating that a first associated region of the second memory is to be integrity-protected.

5. The apparatus of claim 4, wherein the second memory is an off-die memory.

6. The apparatus of claim 5, wherein the first associated region of the second memory is configured to store a portion of the first associated integrity protection tree.

7. The apparatus of claim 6, wherein the second memory is a DRAM.

8. The apparatus of claim 1, wherein each bit of the plurality of bits of the first memory may be set or cleared during run-time.

9. The apparatus of claim 8, wherein the bits are configured to be set or cleared in response to one of an exception in combination with a macro instruction, a dedicated architected instruction, and a system call to a security extension.

10. The apparatus of claim 1, integrated into a computing device.

11. The apparatus of claim 10, the computing device further integrated into a device selected from the group consisting of a mobile phone, a communications device, a computer, a server, a laptop, a tablet, a personal digital assistant, a music player, a video player, an entertainment unit, and a set top box.

12. A method, comprising:
setting a first bit of a plurality of bits of a first memory, each bit of the plurality of bits associated with a region of a second memory, the first bit indicating that an associated first region of the second memory is to be integrity-protected.

13. The method of claim 12, further comprising setting a second bit of the plurality of bits of the first memory, the second bit indicating that an associated second region of the second memory is to be integrity-protected, the second region of the second memory being non-contiguous with the first region of the second memory.

14. The method of claim 12, further comprising setting the first bit in response to one of: an exception in combination with a macro instruction; a dedicated architected instruction; and a system call to a security extension.

15. The method of claim 12, wherein the first memory is an on-die memory, and wherein, in response to the first bit being set, a first MSD of an associated first integrity protection tree is established in the first memory.

16. The method of claim 15, wherein the second memory is an off-die memory, and wherein the associated first region of the second memory stores a subset of the first associated integrity protection tree.

17. The method of claim 15, further comprising clearing the first bit in response to a request that the associated first region of the second memory not be integrity protected.

18. The method of claim 12, wherein each bit of the plurality of bits of the first memory may be set or cleared during run-time.

19. An apparatus, comprising:
a means for storing integrity protection information including a plurality of indicators; and
a means for storing,
wherein each indicator is associated with a region of the means for storing, and each indicator indicates whether the associated region of the means for storing is to be integrity-protected.

20. The apparatus of claim 19, wherein a first indicator is associated with a first region of the means for storing and a second indicator is associated with a second region of the means for storing, wherein the first region and the second region are non-contiguous.

21. A non-transitory computer readable medium comprising instructions which, when executed by a processor, cause the processor to:
set a first bit of a plurality of bits of a first memory, each bit of the plurality of bits associated with a region of a second memory, the first bit indicating whether an associated first region of the second memory is to be integrity-protected.

22. The non-transitory computer readable medium of claim 21, further comprising instructions which, when executed by the processor, cause the processor to:
set a second bit of the plurality of bits of the first memory, the second bit indicating that an associated second region of the second memory is to be integrity-protected, the second region of the second memory being non-contiguous with the first region of the second memory.

23. The non-transitory computer readable medium of claim 21, further comprising instructions which, when executed by the processor, cause the processor to:
clear the first bit in response to a request that the associated first region of the second memory not be integrity protected.
